(19) United States
(12) Patent Application Publication
(10) Pub. No.: US 2025/0033849 A1
(43) Pub. Date: Jan. 30, 2025

(54) METAL CONTAINER FOR ORGANOTIN COMPOUND, REUSING METHOD THEREOF, AND METHOD FOR STORING ORGANOTIN COMPOUND

(71) Applicants: Mitsubishi Chemical Corporation, Tokyo (JP); Gelest, Inc., Morrisville, PA (US)

(72) Inventor: Hiroshi FUKUI, Tokyo (JP)

(21) Appl. No.: 18/748,344

(22) Filed: Jul. 19, 2024

Related U.S. Application Data
(60) Provisional application No. 63/515,143, filed on Jul. 24, 2023.

(51) Int. Cl. B65D 65/42; B08B 9/08; B65D 51/24; B65D 81/20; C07F 7/22

(52) U.S. Cl. CPC B65D 65/42; B08B 9/08; B65D 51/24; B65D 81/2076; B08B 2209/08; C07F 7/2208

(57) ABSTRACT

A metal container for an organotin compound in which the metal container has a diamond-like carbon layer on an inner surface. The diamond-like carbon layer is a fluorine-containing diamond-like carbon layer or at least two diamond-like carbon layers having hydrogen atom contents different from each other, and the diamond-like carbon layer has a thickness of 50 to 15,000 nm.

### CROSS REFERENCE TO RELATED APPLICATIONS

The present application claims the benefits of priority to U.S. provisional application No. 63/515,143, filed on Jul. 24, 2023, the entire disclosure of which is incorporated herein by reference.

### TECHNICAL FIELD

The present disclosure relates to a metal container for an organotin compound suitable for storing and transferring a highly pure organotin compound without impairing its purity in a semiconductor manufacturing process, a CVD processing process, etc., suitable for checking a cleanness degree after washing by not only quantitatively analyzing a residue but also, in a case of a sealed container, visual judgement with an internally provided borescope, and suitable for repeated use via a washing step.

### BACKGROUND ART

An organotin compound has been used in recent years in precise manufacturing process such as information electronic devices and semiconductors. Such a material is often required to have ultrahigh purity, and corrosion resistance, prevention of purity deterioration and impurity contamination, etc. have been strongly required in not only a manufacturing step but also in storing, transporting, and using the material.

As a container for storing the organotin compound, disclosed is, for example, coating an inner surface of a metal container with a polyperfluoroalkoxyethylene coating in order to prevent contamination with a contaminant (PTL 1).

### RELATED ART DOCUMENT

### Patent Document

PTL 1: JP-A-2015-534256

### SUMMARY

However, coating the inner surface of the metal container with the fluororesin etc. has lower hardness of the coating layer than metal, and thereby has a problem of deteriorated scratch resistance and possibility of resin shaved by damage of the layer to be a foreign matter. In addition, the coating layer has high water repellency, and thereby there is a problem that a chemical reagent to be removed may remain inside the container even by washing with solvents etc. in washing after use. Further, the coating layer tends to be charged, and thereby there is a problem that the static electricity tends to attract external dust. The metal container itself without the coating has concern of elution of metals constituting the container from the surface, and has possibility of elution of metals constituting the container surface also by using an acidic aqueous solution in washing.

A demand for further increasing quality of ultraprecise electronic parts represented by semiconductor devices has been recently increased, and the demand for purity management of the used organotin compound etc. has also been furthermore strict. Thus, various investigations have been made on a container subjected to storage and transfer of the organotin compound etc. There has been desire for development of a metal container that is reusable by washing, that can more stably keep the purity of the organotin compound, and that is not disposable and excellence also in an environmental aspect, but such a container has not been achieved actually.

The organotin compound is one of organometallic compounds, and may change to have a different valency by oxidation or reduction. An organic group bonded to tin is also known to be rearranged into a same type or different type of a metal species due to transmetalation. Elution of the metal is concerned in this process, but the metal content as impurity is required to be an ultralow level. Further, when the organotin compound has a hydrolysable group, the organotin compound easily reacts with water to be decomposed and cause purity deterioration, and thereby strict air-tightness is required, and corrosion and contamination with a foreign matter should be also strictly prevented. Particularly, a liquid is easily affected by an eluted material from an object contacted with the liquid during transportation, and the liquid is easily contaminated with impurity compared with a case of a gas state. Specifically, it is difficult to separate an ionized and eluted impurity.

The present disclosure has been made in view of such circumstances, and provides a metal container for an organotin compound that inhibits elution of metal from the metal container to keep its high purity in storing and transferring the organotin compound for a semiconductor, that has excellent durability such as wear resistance, and that is easily washed and easily inspected after the washing. The present disclosure also provides a reusing method of such a metal container and a method for storing an organotin compound using such a metal container.

Accordingly, the present inventors have made earnest study in view of the above circumstances, and consequently found that excellent effect is provided by coating an inner surface of a metal container for containing the organotin compound with a fluorine-containing diamond-like carbon layer (A) or at least two diamond-like carbon layers different from each other (B).

Specifically, the present disclosure has the following aspects.

[i] A metal container for an organotin compound being a metal container for containing an organotin compound, wherein the metal container has a diamond-like carbon layer on an inner surface, the diamond-like carbon layer is a fluorine-containing diamond-like carbon layer (A) or at least two diamond-like carbon layers different from each other (B), and the diamond-like carbon layer has a thickness of 50 to 15,000 nm.
[ii] The metal container for an organotin compound according to [i], wherein the metal container has a metal material having iron, nickel, copper, aluminum, or an alloy of these metals.
[iii] The metal container for an organotin compound according to [i] or [ii], wherein the metal container has a metal material of austenitic stainless steel.
[iv] The metal container for an organotin compound according to [iii], wherein the austenitic stainless steel is vacuum double-melted SUS316L.
[v] The metal container for an organotin compound according to any one of [i] to [iv], wherein the metal container has a bottom having an inner surface shape of an inverted truncated cone.
[vi] The metal container for an organotin compound according to any one of [i] to [v], wherein the organotin compound is represented by the following chemical formula (1),

[Formula]

RpSnXm (1)

wherein R represents a hydrocarbon group optionally substituted with a halogen atom; “p” represents an integer of 0 to 4; X represents a hydrolysable substituent; “m” represents an integer of 0 to 4; and m+p represents 2 or 4.

[vii] The metal container for an organotin compound according to [vi], wherein the organotin compound is represented by the following chemical formula (1),

[Formula]

RpSnXm (1)

wherein R represents a hydrocarbon group optionally substituted with a halogen atom; “p” represents an integer of 1 to 3; X represents a hydrolysable substituent; “m” represents an integer of 1 to 3; and m+p represents 2 or 4.

[viii] The metal container for an organotin compound according to any one of [i] to [vii], wherein the organotin compound has a purity of not less than 99 mol %.
[ix] The metal container for an organotin compound according to any one of [i] to [viii], wherein the metal container has a lid, and the lid has a hole through which an inner surface can be observed with a borescope.
[x] The metal container for an organotin compound according to any one of [i] to [ix], wherein the at least two diamond-like carbon layers have hydrogen atom contents different from each other.
[xi] The metal container for an organotin compound according to any one of [i] to [x], wherein, in the two diamond-like carbon layers, a first diamond-like carbon layer contacted with a container body is a-C:H (hydrogenated amorphous carbon) having a hydrogen atom content of 20 to 40 at %.
[xii] The metal container for an organotin compound according to any one of [i] to [xi], wherein, in the two diamond-like carbon layers, a second diamond-like carbon layer contacted with the organotin compound is ta-C (tetrahedral amorphous carbon) having a hydrogen atom content of not greater than 5 at %.
[xiii] A method for reusing the metal container for an organotin compound according to any one of [i] to [xii], the method comprising steps of: containing an organotin compound in the metal container; using the contained organotin compound; and then containing again a new organotin compound, wherein the method further comprises a step of washing the metal container with at least one liquid selected from the group consisting of nitric acid, hydrofluoric acid, and water before the step of containing again the new organotin compound.
[xiv] A method for storing an organotin compound, comprising steps of: containing an organotin compound in a metal container, wherein the metal container has a diamond-like carbon layer on an inner surface, and the diamond-like carbon layer is any one of a fluorine-containing diamond-like carbon layer (A) or at least two diamond-like carbon layers different from each other (B); and enclosing a noble gas or a mixture of noble gases.

The metal container for an organotin compound of the present disclosure inhibits elution of metal from the metal container to keep the high purity of the organotin compound, has excellent durability such as wear resistance, and is easily washed and easily inspected after the washing.

The high purity can be kept even by long-term storage and transfer, and dealing with the organotin compound by using this metal container can repeatedly and stably provide semiconductor products with excellent quality.

### BRIEF DESCRIPTION OF DRAWINGS

FIG. 1 is an exploded view illustrating a metal container for an organotin compound of an embodiment of the present disclosure.

FIG. 2A is an explanatory view partially illustrating an A-A′ cross section in FIG. 1 and illustrating that a coating layer is a fluorine-containing diamond-like carbon layer (A).

FIG. 2B is an explanatory view partially illustrating an A-A′ cross section in FIG. 1 and illustrating that a coating layer is at least two diamond-like carbon layers different from each other (B).

FIG. 3 is a sectional view entirely illustrating a metal container for an organotin compound of an embodiment of the present disclosure.

FIG. 4 is a table summarizing properties of different stainless steel materials.

### EMBODIMENTS OF THE DISCLOSURE

Hereinafter, the present disclosure will be described in more detail based on embodiments of the present disclosure, but the present disclosure is not limited to the following embodiments.

In the present disclosure, the expression “Y to Z,” wherein Y and Z are given numbers, encompasses a meaning of “preferably greater than Y” or “preferably less than Z” unless otherwise specified, in addition to a meaning of “not less than Y and not greater than Z.”

The expression “not less than Y,” wherein Y is a given number, or “not greater than Z,” wherein Z is a given number, encompasses “preferably greater than Y” or “preferably less than Z.”

Further, the expression “x and/or y,” wherein x and y are given constitutions, means at least one of x and y, and includes: only x; only y; and x and y.

A metal container for an organotin compound according to an embodiment of the present disclosure (which may be referred to as “the present metal container”) is a metal container for containing an organotin compound, wherein the metal container has a diamond-like carbon layer on an inner surface, the diamond-like carbon layer is a fluorine-containing diamond-like carbon layer (A) or at least two diamond-like carbon layers different from each other (B), and the diamond-like carbon layer has a thickness of 50 to 15,000 nm.

Specifically, a body part of the present metal container is metal, and the inner surface thereof is coated with diamond-like carbon (hereinafter, “diamond-like carbon” may be referred to as “DLC”) having a specific thickness.

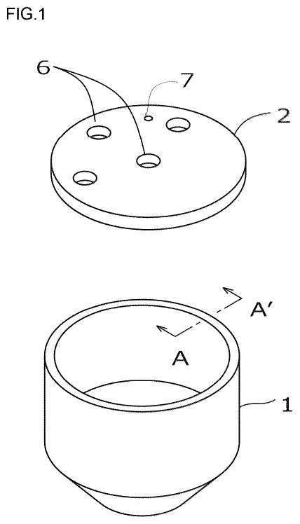

Examples of the present metal container include, as illustrated in FIG. 1, a metal container for an organotin compound for semiconductor manufacturing, the metal container having: a container body 1 having a cylindrical bottom having an inner surface shape of an inverted truncated cone; and a lid 2 for sealing an upper opening of the container body 1. These members may be integrated by welding etc.

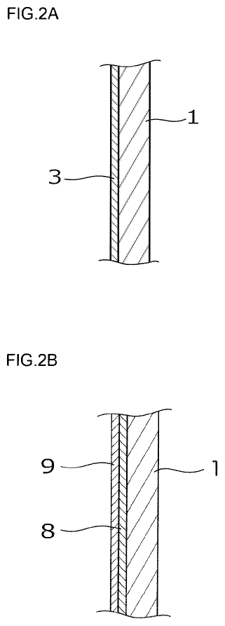

In the container body 1 and the lid 2, an inside of a concave portion inside the container body 1 is a space for containing the organotin compound. The inner surface of the concave portion of the container body 1 is coated with a fluorine-containing DLC layer 3 schematically illustrated in FIG. 2A being an A-A′ cross section in FIG. 1, or coated with a first DLC layer 8 and a second DLC layer 9 as illustrated in FIG. 2B.

The DLC layers including the fluorine-containing DLC layer 3, the first DLC layer 8, and the second DLC layer 9 may be all collectively referred to as “DLC coating layer.”

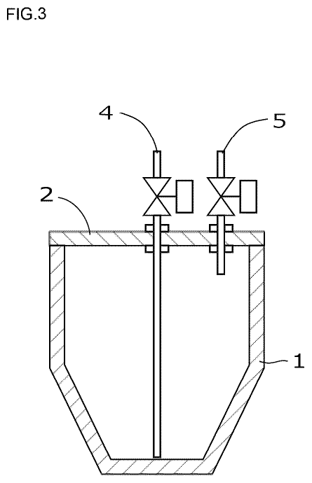

FIG. 3 is a vertical sectional view of an entirety of the present metal container composed of the container body 1 and the lid 2. To the lid 2, various members such as a liquid-discharging pipe 4 and a liquid-injecting pipe 5, which have a liquid level sensor (not illustrated), are attachable. The drawing is illustrative only and not intended as a scale drawing.

Note that the organotin compound contained in the metal container for an organotin compound of the present embodiment is a chemical reagent related to semiconductor manufacturing, and the detail will be described later. The present metal container may be referred to as “container for a chemical reagent.”

### <Container Body>

The present metal container will be described in detail with focusing on the container body 1.

Examples of a metal material for the container body 1, the lid 2, and pipes connected thereto (“4” and “5” in FIG. 3, etc.) include iron, nickel, copper, aluminum, and an alloy of these metals or an alloy of these metals and another metal in combination. These metals are preferably used as a main component (for example, not less than 50 mass %). Among these, austenitic stainless steel, which is an iron-based alloy, is preferred in terms of corrosion resistance and smooth finishing of this surface, SUS316 and SUS304 are preferred in terms of further smooth finishing of this surface, and vacuum double-melted SUS316L in which a trace metal content is lowest is particularly preferred in terms of prevention of the metal elution.

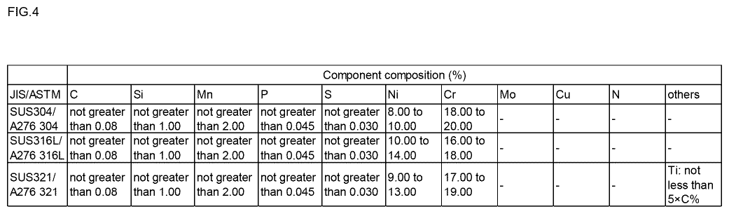

The description of the austenitic stainless steel is in accordance with JIS, and ASTM standard corresponding thereto and each composition are as shown in the following FIG. 4.

See FIG. 4.

Thicknesses of a peripheral wall and a bottom wall of the container body 1 and the lid 2 are appropriately set depending on a size and shape of the present metal container, and an inner face thereof is preferably as smooth as possible in order to strongly adhere to the DLC coating layer. For example, a surface roughness Ra of the inner surface of the metal container before forming the DLC coating layer is preferably not greater than 0.5 μm, more preferably not greater than 0.2 μm, further preferably not greater than 0.1 μm, and most preferably not greater than 0.05 μm.

The surface roughness Ra is a parameter (arithmetical average roughness) in the height direction prescribed in JIS-B 0601, and can be achieved by finish polishing such as, for example, electropolishing and buffing.

Since elution of metal is concerned due to an acid aqueous solution etc. used in washing, the inner surface of the metal material of the container and its lid is preferably subjected to anticorrosive coating, and as for the metal of the inner surface, vacuum double-melted SUS316L in which a trace metal content is lowest is preferably selected among austenitic stainless steel.

To strictly prevent corrosion to decrease impurity, contamination with foreign matter, etc., the lid part is preferably sealed with welding etc. However, some shapes of the container, such as a completely sealed container, tend to retain the organotin compound in the container. In order to reuse the container, a large amount of cleaning solution has to be used, and residual cleaning solution is likely to be left behind. Thus, as long as the container is not disposable, each residue inspection is commonly performed after washing for refilling the container with the organotin compound in order to keep the inside to be clean sealed space.

When the lid of the container is not opened and closed due to the welding etc., it is difficult to visually check the cleanness. The container in which such a material requiring ultrahigh purity is treated is also required to be visually checked with a borescope etc. after washing. The container preferably has a hole on the top surface through which the inner surface can be observed with the borescope, and since the borescope is repeatedly contacted with the hole surface etc. in the inspection, the contacting surface is also desirably DLC-coated in order to impart wear resistance.

In inspecting the inner surface of the container with the borescope etc., when the inner surface of the container made of metal (specifically, stainless steel) is subjected to electropolishing, a reflectance increases and its scattered light may cause unsuitableness for observation with the borescope. In addition, when the surface inside the container is metal which contacts the organotin compound, the aforementioned transmetalation may occur. Thus, any one of the DLC coating layers is preferably a deeply black DLC layer similar to graphite in terms of inhibiting the reflection. Since the fluorine-containing DLC is also deep black, the layer is more preferably the fluorine-containing DLC layer 3. This is because the layer has no reactivity to the organotin compound, has an appropriate contact angle, and has excellent washability, and the washing state can be observed and suitable for storage and reuse.

In a case of a single layer of the DLC layer, some combinations of a type of DLC and a type of the metal constituting the inner surface of the container body 1 may fail to achieve sufficient adhesion. Meanwhile, coating the inner surface singly with a fluororesin causes not only an electrostatic property but also difficulty in obtaining sufficient hardness and durability to prevent damage and peeling.

The organotin compound to be contained in the present metal container is one of organometal compounds, and may change to have a different valency by oxidation or reduction. Its washing residue may have various colors from white to yellow.

Since the fluorine-containing DLC layer 3 is deeply black, the washing residue is easily checked, and a risk of storing or transferring the organotin compound in the presence of the washing residue can be prevented. Further, efficient washing and reuse of the container can be performed.

As for the shape of the container, when there are many parts with the right angle or an acute angle in the container, specifically on the bottom surface, a bottom of the container body 1 preferably has a shape of an inverted truncated cone as illustrated in FIG. 3 because such parts have many chances to be contacted and react with an organic solvent, water, oxygen, etc., which have modest reactivity as the washing residue. A barrel part of the container is typically cylindrical, and the container preferably has a so-called hopper shape as an entirety. This configuration can reduce retained liquid to minimize mixing between the organotin compound and the washing liquid and minimize exposure to an external environment, and can minimize contamination with a foreign matter and corrosion.

For the present metal container, the washing liquid has flowability, and examples thereof include hexane, heptane, methanol, nitric acid, hydrofluoric acid, water, and a mixed aqueous solution thereof. Among these, the washing liquid is preferably nitric acid, hydrofluoric acid, or a mixed aqueous solution thereof, more preferably hydrofluoric acid, and further preferably hydrofluoric acid at a concentration of 0.1 to 40 mass %. These may be used singly or in combination.

### <DLC Coating Layer>

The term “DLC” of the DLC coating layer coating the inner surface of the container body 1 is a general term of a substance containing carbon having both carbon-carbon bonds of a diamond bond (sp3) and a graphite bond (sp2) as a main component (which may refer to a thin film formed with such a substance). Here, “main component” refers to a component at the highest proportion in an object, and the proportion is typically not less than 50 mass %, preferably not less than 80 mass %, more preferably not less than 90 mass %, and may be 100 mass % in the object.

The structure having both the diamond and graphite bonds is commonly called “amorphous structure.” The DLC layer is a film of carbon having both sp3 and sp2, and thereby the DLC layer may be referred to as “amorphous carbon film.”

As for the proportion of sp3/sp2 of the DLC composition, examples of DLC having a high proportion of sp3 and a property close to diamond include “ta-C (tetrahedral amorphous carbon),” and examples of DLC having a high proportion of sp2 and a property close to graphite include “a-C (amorphous carbon).” DLCs in which these DLCs contain hydrogen are respectively called “ta-C:H (hydrogenated tetrahedral amorphous carbon)” and “a-C:H (hydrogenated amorphous carbon),” which tend to have a high effect of reducing a friction coefficient.

The DLC coating layers have various physical properties (features as a material) depending on a proportion of hydrogen atoms incorporated in the crystal structure, the proportions of sp3 and sp2, or presence/absence and regulation of proportions of other elements. The fluorine-containing DLC refers to a copolymer of a hydrocarbon having a double bond or a triple bond and fluorocarbon.

The DLC coating layer coating the inner surface of the container body 1 has a thickness of 50 to 15,000 nm, preferably 100 to 10,000 nm, and more preferably 500 to 5,000 nm or 1,000 to 3,000 nm in terms of the effect of the present disclosure.

Examples of the DLC coating layer include: the fluorine-containing DLC layer (A); or at least two DLC layers different from each other (B). These will be separately described below.

### (A) Fluorine-Containing DLC Layer

When the DLC coating layer is the fluorine-containing DLC layer (A), the fluorine-containing DLC layer coating the inner surface of the container body 1 is a layer formed with a copolymer of DLC and a fluorocarbon, which may be a single layer or a multilayer in which two or more layers are stacked. The fluorine-containing DLC layer in the present embodiment is constituted with one layer as the copolymer of DLC and a fluorocarbon, as illustrated in FIG. 2A.

That is, the fluorine-containing DLC layer 3 is interposed between the metallic container body 1 and the organotin compound to allow the inner surface of the concave portion to have excellent wear resistance, heat resistance, corrosion resistance, pinhole resistance, etc., and to be easily washed.

In a case of the DLC single layer or a fluororesin single layer, the color or low reflectance suitable for the inspection with a borescope may fail to be obtained. Specifically, a common fluororesin coating causes the coating layer to be brown or green, and the DLC single layer causes the coating layer to be transparent or black. Meanwhile, a case of the coating with the fluorine-containing DLC in the present embodiment exhibits deep black and an effect of inhibiting the reflection, which facilitates determination of a contamination state on the inner surface with a borescope.

The DLC single layer may cause a problem of adhesion with the metal, but in the present embodiment, the fluorine-containing DLC layer 3 is a layer also having a property of the fluororesin of excellent adhesion with the metal surface.

The fluororesin single layer has an excessively large contact angle with water to cause a problem of washability due to repellency, or cause damage or peeling due to insufficient hardness of the inner surface. Meanwhile, in the present embodiment, the fluorine-containing DLC layer 3 has a composition having suitable contact angle and hardness.

That is, in the present metal container, a side to be contacted with the inner surface of the container body 1 is coated with the copolymer of DLC and a fluorocarbon, which has excellent adhesion with the metal, to exhibit a composite effect of DLC and the fluororesin.

A fluorine atom content in the fluorine-containing DLC layer 3 is preferably 5 to 40 mass %, and more preferably 20 to 35 mass %. This fluorine atom content can be measured with, for example, combustion ion chromatography.

With focusing on the flexibility, the fluorine-containing DLC layer 3 has an Hv hardness of preferably not less than 1,000 and not greater than 2,500, and more preferably not less than 1,500 and not greater than 2,300.

From the viewpoint of wear resistance, a dynamic friction coefficient “μ” on the surface is preferably not greater than 0.15, and more preferably not greater than 0.1. The lower limit is typically 0.

Although depending on a size of an entirety of the container body 1 and a thickness of the wall, a thickness of the fluorine-containing DLC layer 3 is typically 50 to 10,000 nm, preferably 100 to 5,000 nm, and particularly preferably 500 to 2,000 nm.

If the fluorine-containing DLC layer is too thin, the entire layer will not be able to track the surface roughness of the inner surface of the container body 1. If the fluorine-containing DLC layer 3 is too thick, its uniform coating is difficult to apply and is easily scratched and peeled off.

The fluorine-containing DLC layer 3 preferably has a property of hardly causing static electricity on the surface relative to the insulative material such as the fluororesin having a volume resistivity of not less than 1018 Ω·cm, and thus the fluorine-containing DLC layer 3 preferably has a volume resistivity of not greater than 1010 Ω·cm. With considering a surface having lower water repellency facilitating washing, the water repellency on the surface (contact angle with water) is preferably 50 to 85°, and more preferably 60 to 80° (note that the contact angle of the fluororesin is not less than) 100°.

The fluorine-containing DLC layer 3 may be formed by appropriately selecting a film-forming method from known film-forming methods according to a type of chemical species. Specific examples thereof include the following film-forming methods.

### (1) Chemical Vapor Deposition (CVD)

Thermal CVD
Plasma CVD (high frequency, microwave, direct current, etc.)

### (2) Physical Vapor Deposition (PVD)

Ion plating (direct-current excitation, high-frequency excitation)
Sputtering method (bipolar sputtering, magnetron sputtering, ECR sputtering)
Laser ablation method
Ion-beam deposition
Ion-implanting method

Among these, the plasma CVD is preferable, and more preferably, a high-frequency pulse (RF) is 5 to 15 MHz (including HF band: 13.56 MHz), output is 10 to 1,000 W, and further preferably 300 to 500 W.

Examples of a raw material for CVD include a hydrocarbon-based gas and/or a fluorocarbon-based gas. Examples of the hydrocarbon-based gas include aliphatic hydrocarbons, aromatic hydrocarbons, oxygen-containing hydrocarbons, and nitrogen-containing hydrocarbons, which are gas or liquid at a normal temperature (25° C.). Specific examples thereof include: (1) alkanes such as methane, ethane, propane, butane, hexane, and cyclohexane; (2) alkenes such as ethylene, propylene, 1-butene, and 2-butene; (3) alkynes such as acetylene, methylacetylene, and ethylacetylene; and (4) aromatic hydrocarbons such as benzene, toluene, and xylene. Among these, benzene, toluene, o-xylene, m-xylene, p-xylene, cyclohexane, etc., which have not less than 6 carbon atoms, are preferable. These may be used singly, or in combination.

Examples of the fluorocarbon-based gas include C3F6: hexafluoropropene, C4F6: hexafluorobutadiene, C6F6: hexafluorobenzene, C6F12, C6F14, C7F8, C7F14, C7F16, C8F16, C8F18, C9F18, C9F20, C10F8, C10F18, C11F20, C12F10, C13F28, C15F32, C20F42, C24F50, C3F3N3, C3F9N: tris(trifluoromethyl)amine, C5F5N, C6F4N2, C6F9N3, C6F12N2, C6F15N: tris(pentafluoroethyl)amine, C7F5N, C8F4N2, C9F21N: tris(heptafluoropropyl)amine, C12F4N4, C12F27N, C14F8N2, C15F33N, C24F45N3, C3F6O: hexafluoroacetone, C4F6O3, C4F8O: octafluorooxolane, C5F6O3, C6F4O2, C6F10O3, C8F4O3, C8F8O, C8F8O2, C8F14O3, C13F10O, C13F10O3, C2F6O(C3F6O)n(CF2O)m, wherein “n” and “m” represent an integer, and C7F5NO. These may be used singly, or in combination.

These hydrocarbon-based gas and fluorocarbon-based gas may be mixed for forming the film of the desired fluorine-containing DLC.

The fluorine-containing DLC layer 3 has a single-layer structure in the present embodiment, but the number of layers may be two or more. A large number of the DLC layers may be stacked to exhibit a composite effect of the DLC layers.

At Least Two DLC Layers Different from Each Other (B)

Described as the case where the DLC coating layer is at least two DLC layers different from each other (B) is a case where the DLC coating layer coating the inner surface of the container body 1 is a multilayer in which two or more DLC layers are laminated. In the present disclosure, the multilayer is composed of two layers of a first DLC layer 8 and a second DLC layer 9 as illustrated in FIG. 2B.

That is, according to the present metal container, the inner surface of the concave portion is coated with the DLC coating layer. Compared with a plastic coating surface (such as fluorine), this DLC coating layer has excellent wear resistance, heat resistance, corrosion resistance (present with the fluorine), and pinhole resistance. In addition, the inner surface is easily washed and hardly charged. Therefore, the organotin compound contained in the concave portion is not contaminated with a foreign matter.

As the DLC coating layer in this case, two or more layers having different hydrogen atom contents and/or proportions between sp3 and sp2 are necessarily provided. Coating with the two or more different DLC layers yields properties of corrosion resistance against a chemical reagent to be contacted with the inner surface, such as high hardness, wear resistance, and color tone. Accordingly, the high purity of the organotin compound can be kept even with storage and transfer in a long term. In addition, the metal surface of the present metal container is not exposed, and thereby the metal container can be repeatedly washed with an acidic aqueous solution etc., which is suitable for reuse of the container.

Therefore, treating the organotin compound, which is a chemical reagent for semiconductor manufacturing, by using the present metal container can stably provide semiconductor products with excellent quality.

The DLC single layer may fail to sufficiently achieve good adhesion depending on a combination between the type of DLC and the type of metal constituting the inner surface of the container body 1. Thus, it is preferable that, as the present embodiment, a layer composed of DLC (the first DLC layer 8) having excellent adhesion with metals on the side contacted with the inner surface of the container body 1 is provided and that a layer composed of DLC (the second DLC layer 9) having excellent properties to keep the purity of the organotin compound is formed to be stacked onto the former layer.

The DLC single layer may also fail to obtain color and a low reflectance suitable for inspection with a borescope depending on a combination between the type of DLC and the type of metal constituting the inner surface of the container body 1. Thus, at least one of the DLC layers preferably has a DLC layer having properties close to the graphite structure having a high sp2 proportion, and more preferably has such a layer as a layer on the side contacted with the inner surface of the container body 1. Since the DLC having a high sp2 proportion exhibits deep black to reduce reflectance of light, washing residue can be easily inspected with a borescope compared with a metal inner surface and a fluororesin coating.

The present embodiment uses the bilayer structure of the first DLC layer 8 and the second DLC layer 9, but more than two DLC layers can be stacked to exhibit a combined effect of the DLC layers.

As the first DLC layer 8 in the present embodiment, DLC being relatively soft and having excellent adhesion with the metal surface, which is properties close to graphite, is preferably used. Specifically, a-Camorphous carbon) is preferable, and a-C:H (hydrogenated amorphous carbon) having a hydrogen atom content of 20 to 40 at %, particularly 25 to 35 at %, is preferable. Focusing on this flexibility, Hv hardness is preferably within a range of 1,000 to 4,000. This configuration yields deep black color to facilitate observation with a borescope.

A thickness of the plurality of the DLC layers is preferably 1,000 to 15,000 nm as an entirety. The thickness is more preferably 1,000 to 10,000 nm.

Although depending on a size of an entirety of the container body 1 and a thickness of the wall, a thickness of the first DLC layer 8 is typically preferably 500 to 10,000 nm, and more preferably 2,000 to 10,000 nm. That is, if the first DLC layer 8 is excessively thin, adequate surface coverage of the entirety of the DLC coating layer with the surface roughness of the inner surface of the container body 1 may be deteriorated. The thickness within the above range tends to efficiently yield adequate surface coverage.

As the second DLC layer 9, DLC being relatively hard and having rather poor tightness with the metal surface but excellent wear resistance, corrosion resistance, pinhole resistance, etc., which are properties close to diamond, is preferably used. Specifically, preferable is tetrahedral amorphous carbon (ta-C) containing absolutely no hydrogen atom or not greater than 5 at % of hydrogen atoms if contained. Focusing on its hardness, DLC having Hv hardness within a range of 4,000 to 7,000 is preferable. From the viewpoint of wear resistance, a dynamic friction coefficient “μ” on the surface is preferably not greater than 0.15, and more preferably not greater than 0.1. The lower limit is typically 0.

The second DLC layer 9 preferably has a property of hardly causing static electricity on the surface relative to the insulative material such as the fluororesin having a volume resistivity of not less than 1018 Ω·cm, and thus the second DLC layer 9 preferably has a volume resistivity of not greater than 1010 Ω·cm. With considering a surface having lower water repellency facilitating washing, the water repellency on the surface (contact angle with water) is preferably 50 to 85° (note that the contact angle of the fluororesin is not less than) 100°.

A thickness of the second DLC layer 9 is preferably 50 to 5,000 nm, and more preferably 100 to 3,000 nm. This thickness depends on the proportions such as the hydrogen content in the first DLC layer 8.

The second DLC layer 9 is extremely hard and it is difficult to form a thick film. Thus, the second DLC layer 9 may be provided as further multiple layers. Regulating the hydrogen atom content in the first DLC layer 8 tends to sufficiently and efficiently yield the excellent effect by the DLC of keeping the purity of the organotin compound.

In any cases where the DLC coating layer is the bilayer or multilayer of two or more layers, the thickness of the DLC coating layer is set to be within the range of 1,000 to 15,000 nm as the entirety. The preferable thickness depends on properties of the layers. That is, the preferable thickness depends on composition classification (hydrogen content and sp3/sp2).

If the thickness of the DLC coating layer is excessively thin, the properties of the DLC may not be sufficiently exhibited as noted above, and the thickness within the above range tends to efficiently yield the effect. When the DLC coating layer is the multilayer, a layer to be exposed on the outermost surface (layer to be contacted with the organotin compound) is desirably the DLC layer having properties similar to those of the second DLC layer 9.

The DLC coating layer may be formed by appropriately selecting a film-forming method from known film-forming methods according to the type of DLC. Specific examples thereof include the following film-forming methods. When types of the DLC are changed to laminate two or more of the DLC layers and a same film-forming method is used for both the DLC layers as the present embodiment, the films may be continuously formed by using a single apparatus with switching the film-forming materials.

### (1) Chemical Vapor Deposition (CVD)

Thermal CVD
Plasma CVD (high frequency, microwave, direct current, etc.)

### (2) Physical Vapor Deposition (PVD)

Ion plating (direct-current excitation, high-frequency excitation)
Sputtering method (bipolar sputtering, magnetron sputtering, ECR sputtering)
Laser ablation method
Ion-beam deposition
Ion-implanting method

### <Lid>

Next, the lid 2 of the present embodiment will be described in detail.

The lid 2 is provided with: a plurality of holes 6 for connecting an organotin-compound-injecting pipe for injecting the organotin compound into the container, an insertion tube for a borescope, a liquid-discharging pipe, a pressure-regulating pipe, a liquid level sensor, etc.; a hole 7 for attaching the electrode; etc. with a predetermined arrangement. These pipes are connected to the lid 2, and integrated in an automatic organotin compound supplying system to be arranged above the semiconductor manufacturing line in a state of attaching the electrode. An insertion port for the borescope may be selected from convenient holes.

As a metal used for the lid 2, a metal same as the metal used for the container body 1 is preferably used. Note that both the materials are not necessarily same.

On a lower surface of the lid 2 (surface opposite to an opening on the upper surface of the container body 1), a coating layer similar to the DLC coating layer (the fluorine-containing DLC layer (A) or the at least two DLC layers different from each other (B)) provided on the container body 1 side is preferably provided in term of keeping the purity of the organotin compound in the container. Note that the coating layer provided on the lid 2 and the coating DLC layer provided on the container body 1 are not necessarily same.

According to the present metal container, at least the concave inner surface of the container body 1 to contain the organotin compound is coated with the DLC coating layer, and thus, the present metal container has excellent wear resistance, heat resistance, corrosion resistance, pinhole resistance, etc., and is easily washed and hardly charged compared with a surface of 100-mass % fluororesin coating. Therefore, during storage and transfer of the organotin compound for semiconductor manufacturing in a long term in this container, the metal on the container body 1 side is hardly eluted into the organotin compound, hardly peeled, and hardly charged to contaminate the organotin compound with a foreign matter.

In the present metal container, “corrosion weight loss relative to iron (III) chloride hexahydrate” measured by the following method is typically not greater than 0.05 mg/m2·hr, and particularly preferably not greater than 0.01 mg/m2·hr. This corrosion weight loss supports that the present metal container exhibits excellent performance of keeping the purity of the organotin compound. Although a fluororesin-coated product (polytetrafluoroethylene: PTFE) yields a similar result, such a product is charged to attract dust in drying by wiping to yield a number slightly larger than the actual number. This is considered to cause contamination.

The above “corrosion weight loss relative to iron (III) chloride hexahydrate” refers to a value (g/m2·hr) determined by: dissolving iron (III) hexahydrate in 1/10 N hydrochloric acid at 6 mass %, and filling the present metal container with the solution in the convex portion for containing the organotin compound; leaving the container to stand at 25° C. for 24 hours; then measuring a change in mass before and after the test of the present metal container with a precision balance to be divided by a total area of the inner surface of the convex portion.

Since the convex portion of the container body 1 has an inner shape to be easily washed, the inside of the container can be cleaned in a short time, and the organotin compound is easily handled, such as replacement operation. In addition, the container inside is hardly charged compared with the single fluororesin, and thereby the container also has an advantage that dust etc. hardly enters the container inside from an outside during opening and closing of the lid 2, etc.

Accordingly, supplying the organotin compound in the semiconductor manufacturing process by using the present metal container can prevent generation of defect products due to decrease in purity of the organotin compound and can manufacture the high-quality semiconductors with a high yield.

As noted above, the coating layer may be provided on the lower surface of the lid 2 in the present embodiment, and on the inner circumferential surface of the holes 6 and 7 etc. for attaching the pipes, the liquid level sensor, the electrode, the borescope, etc. to the lid 2, the DLC coating layer may also be provided similarly to the lower surface of the lid 2. Providing the DLC coating layer smoothens the inner circumferential surface of the holes 6 and 7, etc., and thereby a metal chip is not generated during attachment or detachment of the pipe or the electrode, and the inner circumferential surface hardly attracts external dust etc. The holes 6 and 7 also function as holes for attaching the pipes and devices such as the liquid level sensor, and for example, the hole to which the pipe for taking out the liquid in the container is attached can also function as the hole for attaching the borescope.

In the present metal container, the shape of the container body 1 and the shape of the lid 2 are not necessarily the shapes in the above embodiment, and may be any shape as long as the container body and the lid are used for the organotin compound for the semiconductor manufacturing. The inner surface of the convex portion of the container to contain the organotin compound is at least coated with the fluorine-containing DLC or multi-layered DLC having the specific thickness.

For example, when a member corresponding to the lid 2 is incorporated in a part of the organotin-compound-supplying equipment and only a container body is singly handled, the single container body is “the metal container for an organotin compound” of an embodiment of the present disclosure. When the container body is composed of, for example, two members of an external container and an internal container, the internal container provided with the convex portion to contain the organotin compound is “the metal container for an organotin compound” of an embodiment of the present disclosure.

### <Organotin Compound>

The organotin compound to be contained in the present metal container is one of organometal compounds, and may change to have a different valency by oxidation or reduction. Washing residues of the organotin compound have various colors from white to yellow.

Thus, with the present metal container, such a washing residue can be observed, a risk of retaining and transferring the organotin compound in the presence of the residue can be prevented, and the present metal container can be efficiently washed and reused.

Particularly, an organotin compound used as a precursor of CVD etc. is required to have high purity (not less than 99 mol %) in a state before film formation. Many of the organotin compounds have high reactivity with water vapor, oxygen, etc., and the organic group bonded to tin is known to be rearranged to a same or different metal species due to transmetalation. Although elution of the metal is concerned in this process, the metal content as an impurity is required to be ultralow level. Further, when the organotin compound has a hydrolysable group, such an organotin compound easily reacts with water to be decomposed, which leads to decrease in the purity. Thus, strict air tightness is also required, and corrosion and contamination also need to be strictly avoided.

Specifically, the organotin compound with high purity is generally liquid, and in the container and transferring line for containing or transferring the organotin compound, it is an important challenge to keep the high purity.

Note that, for using the organotin compound as a raw material for manufacturing a semiconductor, the impurity content is required to be as low as possible. Specifically, the content of metals other than tin is preferably not greater than 30 ppb, more preferably not greater than 10 ppb, further preferably not greater than 2 ppb, particularly preferably not greater than 1 ppb, and most preferably 0 ppb.

When a plurality of types of the organotin compound is mixed, a purity of a mixture of each of the organotin compounds is desirably not less than 99 mol %, and particularly desirably not less than 99.9 mol %.

In the present disclosure, the purity of the organotin compound (in terms of tin) can be measured by using NMR (available from JEOL, Ltd., JNM-ECZ400).

The metals other than tin can be quantified by using ICP-MS (high-frequency emission mass spectrometry, available from Agilent Technologies,

### Inc., Agilent 7700).

The organotin compound used for the present metal container is a compound in which an organic group is directly bonded to a tin atom, and a group other than the organic group may be substituted at any number or may not be substituted. The organotin compound may be a compound having a tin-tin bond, or may be a compound having a plurality of tin atoms bonded via an organic group or another group.

Examples of these organotin compounds preferably include an organotin compound represented by the following chemical formula (1),

[Formula]

RpSnXm (1)

wherein R represents a hydrocarbon group optionally substituted with a halogen atom; “p” represents an integer of 0 to 4; X represents a hydrolysable substituent; “m” represents an integer of 0 to 4; and m+p represents 2 or 4.

Particularly, preferably used is a compound wherein, in the chemical formula (1), R represents a hydrocarbon group optionally substituted with a halogen atom; “p” represents an integer of 1 to 3; X represents a hydrolysable substituent; “m” represents an integer of 1 to 3; and m+p represents 2 or 4.

In the formula, “R” represents a hydrocarbon group, and represents a hydrocarbon group having preferably 1 to 30 carbon atoms, more preferably 1 to 15 carbon atoms, further preferably 1 to 10 carbon atoms, and particularly preferably 2 to 6 carbon atoms. Examples of the hydrocarbon group include: alkyl groups such as methyl group, ethyl group, n-propyl group, isopropyl group, n-butyl group, isobutyl group, t-butyl group, cyclopentyl group, cyclohexyl group, and 1-methylcyclopentyl group; alkenyl groups such as vinyl group, 1-propenyl group, 2-propenyl group, 2-butenyl group, and 3-butenyl group; aryl groups such as phenyl group and tolyl group; and aralkyl groups such as benzyl group.

In the formula, “X” means a hydrolysable substituent, and examples thereof include: halogen atom; amino group, alkoxy group (—OR′), alkynide (R′C≡C), azide (N3-), dialkylamino group (—NR′2) and (—NR′R″), alkylcarbonylamino group (—N(R′)C(O)R′), (—N(R′)C(O)R″), and (—N(R″)C(O)R′), carbonyloxy group (—OCOR′), and carbonylamino group (—N(H)C(O)R′). R′ and R″ each independently represent a hydrocarbon group having 1 to 10 carbon atoms. Among these, X preferably represents dialkylamino group, alkoxy group, alkylcarbonylamino group, halogen, or carbonyloxy group, particularly preferably dialkylamino group (—NR′2) or alkoxy group (—OR′), and further preferably dimethylamino group, diethylamino group, or tertiary alkoxy group.

In the formula, “p” represents an integer of 0 to 4, and preferably an integer of 1 to 3, and “m” represents an integer of 0 to 4, and preferably an integer of 1 to 3. Since the tin atom is typically divalent or tetravalent, p+m=2 or 4 in typical, and p+m=4, which indicates chemically more stable tetravalent, is preferable. The organotin compound suitable to be contained in the present metal container is a compound being liquid at a normal temperature (25° C.). When the organotin compound is used as a precursor of a resist for a semiconductor, containing a plurality of the hydrolysable substituents enables efficient film formation. Therefore, “p” preferably represents 1 or 2, and particularly preferably 1.

X is subjected to hydrolysis, and then forms XH to be removed. XH is desirably evaporated under a reduced pressure and/or under heating, and XH preferably has a boiling point of preferably not greater than 200° C., and particularly not greater than 100° C. at a normal pressure.

In the present embodiment, among the above organotin compounds, an organotin compound represented by the following chemical formula (2) is particularly preferably used in terms of the effect. “R” in the following chemical formula (2) represents a hydrocarbon group same as of “R” in the chemical formula (1), and preferably having 1 to 15 carbon atoms, more preferably 1 to 10 carbon atoms, and further preferably 2 to 6 carbon atoms.

“X” in the following chemical formula (2) is same as of “X” in the chemical formula (1), and particularly preferably represents dialkylamino group, alkoxy group, alkylcarbonylamino group, halogen, or carbonyloxy group, X particularly preferably represents dialkylamino group or alkoxy group, and further preferably dialkylamino group (—NR′2) or alkoxy group (—OR′). Here, R′ represents a hydrocarbon group having 1 to 6 carbon atoms.

[Formula]

RSnX3 (2)

In the formula (2), R represents a hydrocarbon group having 1 to 30 carbon atoms; and X represents a hydrolysable substituent.

Examples of such an organotin n compound include t-butyltris(dimethylamino)tin, n-butyltris(dimethylamino)tin, t-butyltris(diethylamino)tin, sec-butyltris(dimethylamino)tin, n-pentyltris(dimethylamino)tin, isobutyltris(dimethylamino)tin, isopropyltris(dimethylamino)tin, t-butyltri-t-butoxytin, t-butyltri-t-amyloxytin, n-butyltri-t-butoxytin, or isopropyltri-t-butoxytin. These may be used singly or in combination.

The organotin compound may be diluted with a solvent, apart from its purity. In this case, specific examples of the usable solvent include, but not limited to: aromatic hydrocarbons such as toluene, xylene, and benzene; aromatic ethers such as anisole; aliphatic hydrocarbons such as hexane, heptane, octane, cyclohexane and methylcyclohexane; esters such as ethyl acetate, butyl acetate, butyl propionate, and propylene glycol monomethyl ether acetate; ethers such as diethyl ether, diisopropyl ether, methyl t-butyl ether, cyclopentyl methyl ether, tetrahydrofuran, and 1,4-dioxane; alcohols such as methanol, ethanol, 1-propanol, isopropanol, 1-butanol, t-butanol, 4-methyl-2-propanol, ethylene glycol, and propylene glycol; ketones such as methyl ethyl ketone, methyl isobutyl ketone, and cyclohexanone; and amides such as dimethylformamide, dimethylacetamide, and N-methylpyrrolidone. Among these, esters, ethers, ketones, and amides that are aprotic highly polar solvents are preferable because these solvents dissolve a compound in proceeding of hydrolysis at a certain degree, ethers and amides that have high coordination ability is more preferable, and amides are particularly preferable. In addition, alcohols that are protic highly polar solvents are preferable because the hydrolysable substituent represented by X is replaced and the solubility is maintained for the hydrolysis to proceed, and t-butanol, t-amylalcohol and 4-methyl-2-propanol are more preferable.

An extent of the dilution is appropriately adjusted according to its use form. For example, when the organotin compound is used for a spin-coating process in resist film formation, the dilution is performed within a range of typically 0.005 to 1.4 M (mol/L), preferably within a range of 0.02 to 1.0 M (mol/L), and more preferably within a range of 0.05 to 0.5 M (mol/L) based on the organotin compound.

### <Method for Storing Organotin Compound>

The present metal container has the DLC coating layer with the specific thickness on the surface inside the container, and thereby inhibits elution of metal from the container to keep the high purity of the organotin compound and to have excellent durability such as wear resistance. Thus, the high purity can be kept even with storage and transfer in a long term. Therefore, the organotin compound is preferably contained in the present metal container as the method for storing an organotin compound.

### <Reusing Method of Metal Container>

The present metal container can contain again a new organotin compound (reuse) after the container contains the organotin compound and the organotin compound is used. As the reusing method of the metal container, before the metal container is filled with the organotin compound again, the metal container is preferably washed with a washing liquid in order to keep the high purity.

Specifically, in:
a step (1) of containing the organotin compound in the present metal container;
a step (2) of using the contained organotin compound; and thereafter
a step (3) of containing the new organotin compound again,
   before the step (3) of containing the new organotin compound again, the steps preferably further have a step of washing the metal container with at least one type of liquid selected from the group consisting of nitric acid, hydrofluoric acid, and water.

Examples of the washing liquid include hexane, heptane, methanol, nitric acid, hydrofluoric acid, water, and a mixed aqueous solution thereof. Among these, nitric acid, hydrofluoric acid, and a mixed aqueous solution thereof are preferable, hydrofluoric acid is more preferable, and hydrofluoric acid having a concentration of 0.1 to 40 mass % is further preferable. These may be used singly or in combination.

It is generally concerned that metal is eluted with an acid aqueous solution etc. that can be used for washing, but according to the present metal container, cleanness inside the container can be kept with almost no elution, and the organotin compound can be retained with high purity even with storage and transfer in a long term.

Therefore, treating the organotin compound by using this metal container can repeatedly and stably provide semiconductor products with excellent quality.

### <Application>

Due to excellent wear resistance and corrosion resistance, the present metal container is suitable for storing and transporting various chemicals represented by the organotin compound. In the actual use, the organotin compound represented by the chemical formula (1) is contained in the present metal container, and noble gas or a mixture of noble gases is enclosed to store the organotin compound. By containing as above, the organotin compound can be stored in a certain term and can be transported.

Due to excellent wear resistance and corrosion resistance, the present metal container can be reused by washing the used container. Specifically, the reusing method of the present metal container comprises: containing the organotin compound represented by the chemical formula (1) in the present metal container; using the organotin compound; and then containing the new organotin compound again, before the new tin compound is added again, the present metal container is washed with nitric acid, hydrofluoric acid, or a mixed aqueous solution thereof.

### EXAMPLES

Next, the present disclosure will be specifically described with Examples. Note that the present disclosure is not at all limited by the following Examples. In examples, a simple description “%” means basis on mass.

<<Case where Coating Layer is Fluorine-Containing DLC Layer (A)>>

### Example A-1

The container illustrated in FIGS. 1 and 3 and composed of the container body 1 and the lid 2 is produced by using vacuum double-melted SUS316L. The inner surface of the container body 1 has a cylinder shape on an upper part and an inverted truncated cone shape on a bottom part. The cylinder shape on the upper part has a diameter of 70 mm, the bottom surface has a diameter of 35 mm and a height of 150 mm (the cylinder at the upper part has a height of 80 mm and the inverted truncated cone at the bottom part has a height of 70 mm). A thickness of the bottom wall is 13 mm, and a thickness of the circumferential wall is 9 mm.

The inner surface of the container body 1 is polished with waterproof abrasive paper (#1200) and buffing (alumina 0.05 μm), and subjected to a defatting treatment with acetone to be finished to have a surface roughness Ra of not greater than 0.02 μm.

On the lid 2, holes (6 and 7 in FIG. 1) are formed for attaching various members such as a liquid-discharging pipe 4 and a liquid-injecting pipe 5, which have a liquid level sensor, and a borescope.

On the inner surface of this container body 1, on the lower surface of the lid 2, and on the inner circumferential surface of the hole 6, a fluorine-containing DLC layer 3 is formed by plasma CVD (high-frequency pulse: 10 MHz, output: 400 W, raw material gas: 1:1 mixture of acetylene and octafluoropropane) to obtain a metal container for retaining an organotin compound being a chemical reagent for manufacturing a semiconductor. Details of the layer are as follows.

### Fluorine-Containing DLC Layer

Type of DLC: fluorine atom content: 30%, Hv hardness: 2,000, dynamic friction coefficient (u) on the layer surface: 0.1, volume resistivity: 109 Ω·cm, water repellency (contact angle with water): 80°
Thickness of layer: 1,000 nm

### Comparative Example A-1

A metal container without the coating layer is obtained in the same manner as in Example A-1 except that the fluorine-containing DLC layer is not formed in the Example A-1.

### Comparative Example A-2

A metal container with a coating layer is obtained in the same manner as in Example A-1 except that the fluorine-containing DLC layer is changed to a resin layer of polyperfluoroalkoxyethylene, which is a high-purity fluororesin (a thickness of the fluororesin layer: 1,000,000 nm), in the Example A-1.

### Comparative Example A-3

A metal container with a coating layer is obtained in the same manner as in Example A-1 except that the fluorine-containing DLC layer is changed to a DLC layer formed with a DLC single layer in the Example A-1.

### Comparative Example A-4

A metal container with a coating layer is obtained in the same manner as in Example A-1 except that a thickness of the fluorine-containing DLC layer is 20,000 nm in the Example A-1.

The product of Example and the products of Comparative Examples are evaluated on the following items, and compared. The following Table 1 shows the results.

### Purity Retainability

The metal container is filled with 1.7 L of isopropyltris(dimethylamino)tin as the organotin compound with a purity of as high as 99.9 mol % (metal content of not greater than 30 ppb), and stored at 25° C. for one week. Contents of metals constituting SUS316L (manganese, nickel, iron, cobalt, and chromium, hereinafter referred to as “SUS metal”) in the organotin compound in this state are measured by ICP-MS and evaluated on the following criteria.

Very Good: The SUS metal contents are not greater than 30 ppb.

Bad: The SUS metal contents are greater than 30 ppb.

### Durability (Wear Resistance)

The container body 1 and the lid 2 illustrated in FIG. 3 are washed, and then the liquid-discharging pipe 4 provided with a liquid level sensor is inserted through the lid 2. The insertion and extraction of the liquid-discharging pipe 4 are repeated 100 times, and then the inner circumferential surface of the hole is visually observed and evaluated on the following criteria.

Very Good: The clean surface is kept without a scratch, peeling, etc.

Good: There is a scratch that cannot be visually checked.

Bad: A scratch, peeling, etc. are observed.

### Visibility

Ease of surface inspection inside the container with a borescope is evaluated on the following criteria.

Very Good: The reflectance is low, and the color is deep black with easy observation.

Good: The reflectance is not high, but the color is not deep black.

Bad: The reflectance is high, and scattered light causes low visibility.

### Reusability (Washability)

When the container body is washed with hydrofluoric acid (1% aqueous solution) and refilled with the organotin compound, reusability while keeping the high purity is evaluated on the following criteria.

Very Good: The washing can be sufficiently performed to keep the high purity.

Good: The washing can be sufficiently performed, but the high purity cannot be kept.

Bad: The washing is insufficient. The washing is insufficient due to water repellency, and a foreign matter enters peeling of the layer and a scratch to be hardly removed.

TABLE 1

| | | Comparative | Comparative | Comparative | Comparative |
|---|---|---|---|---|---|
| | Example A-1 | Example A-1 | Example A-2 | Example A-3 | Example A-4 |
| Layer composition | Fluorine- | none | Fluororesin | DLC | Fluorine- |
| | containing | | | | containing |
| | DLC | | | | DLC |
| Layer thickness (nm) | 5,000 | none | 1,000,000 | 5,000 | 20,000 |
| Purity retainability | Very Good | Bad | —* | —* | —* |
| (storability) | | | | | |
| Durability (wear resistance) | Very Good | —* | Bad | Good | Bad |
| Visibility (reflectance) | Very Good | Bad | Good | Good | Very Good |
| Reusability (washability) | Very Good | Good | Bad | Bad | Bad |

*Not performed

As noted above, the SUS metal content in the organotin compound stored in the container of Comparative Example A-1 is greater than 30 ppb, and the purity retainability is poor. In contrast, the SUS metal content in the organotin compound stored in the container of Example A-1 is not greater than 30 ppb. That is, it is supported that the metal container for an organotin compound of the present embodiment demonstrates excellent performance in the purity retention of the organotin compound without elution from the metal container.

The container of Comparative Example A-2 is easily scratched because the coating layer is singly the fluororesin. In the container of Comparative Example A-3, the coating layer is singly the DLC, thus has poor adhesiveness to the metal container to easily cause peeling. In the container of Comparative Example A-4, the coating layer is too thick to perform the coating with a uniform thickness, and thus easily scratched and peeled. Such a phenomenon tends to cause more obvious difference with an accurate structure on the lid surface. In contrast, in the container of Example A-1, the fluorine-containing DLC layer is hard and has excellent adhesiveness to the metal container, and thus durability (wear resistance) is excellent even with repeated insertion and extraction of the liquid-discharging pipe 4.

Therefore, it is presumed that the liquid in the container is not contaminated with a foreign matter generated from a scratch in the container or with a foreign matter such as a fragment derived from plastics around the sensors.

Further, in the container of Comparative Example A-1, the surface inside the container is made of stainless steel polished by buffing, and thereby the reflectance increases to cause poor visibility due to its scattered light. In the container of Comparative Example A-2, the coating layer is made of singly the fluororesin and brown or green, and in the container of Comparative Example A-3, the coating layer is made of singly DLC and thus blacky transparent. In contrast, in the container of Example A-1, the inner surface is coated with the fluorine-containing DLC layer, and thereby the color is deep black and has the reflection-inhibiting effect, which can easily determine the contamination state on the inner surface with a borescope.

The container of Comparative Example A-1 has poor visibility of the contamination state on the inner surface as noted above, and failure of washing may occur. In the container of Comparative Example A-2, the fluororesin layer being the coating layer has high water repellency, and thereby the organotin compound tends to remain on the inner surface, and causes difficulty in washing for removing the organotin compound with washing water due to the water repellency of the fluororesin. In the containers of Comparative Examples A-3 and A-4, if a foreign matter enters the peeled portion of the coating layer, it is not easy to remove the foreign matter by washing. In contrast, in the container of Example A-1, the inner surface is coated with the fluorine-containing DLC layer, and thereby has appropriate hydrophilicity (smaller contact angle with water than the fluororesin) and excellent washing ease. Therefore, the container can be washed after use of the organotin compound and contain the new organotin compound again while keeping the high purity (reuse).

<<Case where Coating Layer is at Least Two DLC Layers Different from Each Other (B)>>

### Example B-1

The bottomed cylindrical container illustrated in FIGS. 1 and 3 and composed of the lid and the container body is produced by using SUS304.

The outer shape of the container body is 140 mm in diameter×110 mm in height, the thickness of the bottom wall is 13 mm, and the thickness of the circumferential wall is 9 mm. A capacity of the concave portion for containing a chemical reagent is 1,200 mL. The inner surface of the concave portion is polished with waterproof abrasive paper (#1200) and buffing (alumina 0.05 μm), and subjected to a defatting treatment with acetone to be finished to have a surface roughness Ra of not greater than 0.02 μm.

On the inner surface of the concave portion of this container body, on the lower surface of the lid, and on the inner circumferential surface of the holes for attaching the pipe and the liquid level sensor (see 6 and 7 in FIG. 1), the first DLC layer and the second DLC layer are formed in this order by plasma CVD to obtain a container for a chemical reagent with a coating layer. Details of the layers are as follows.

(1) First DLC Layer (a Side Contacted with the Metal Surface)

Type of DLC: a-C:H (hydrogen atom content: 30%, Hv hardness: 2,000)

Thickness of layer: 9,000 nm

(2) Second DLC Layer (a Side Contacted with the Chemical Reagent)

Type of DLC: ta-C (hydrogen atom: not greater than 5%, Hv hardness: 6,000, dynamic friction coefficient (μ) on the layer surface: 0.1, volume resistivity: 109 Ω·cm, water repellency [contact angle with water]: 80°)

Thickness of layer: 1,000 nm

### Example B-2

The material of the container is changed to vacuum double-melted SUS316L. A container for a chemical reagent with a coating layer is obtained in the same manner as in Example B-1 other than the above.

### Comparative Example B-1

The inner surface of the concave portion of the container body and the lower surface of the lid are resin-coated with the fluororesin (a thickness of the fluororesin layer: 100 μm). On the inner circumferential surface of the hole, the coating layer is not provided to retain the metal base. A container for a chemical reagent with a coating layer is obtained in the same manner as in Example B-1 other than the above.

The products of Examples and the product of Comparative Example are evaluated on the items of the above [Durability (wear resistance)] and [Reusability (washability)], and compared. The following Table 3 shows the results.

TABLE 3

| | | | Comparative |
|---|---|---|---|
| | Example B-1 | Example B-2 | Example B-1 |
| Metal composition of | SUS304 | SUS316L | SUS304 |
| container | | | |
| Layer composition | First DLC: a-C:H | | Fluororesin |
| | Second DLC: ta-C | | |
| Layer thickness | First DLC: 9,000 nm | | 100 μm |
| | Second DLC: 1,000 nm | | |
| Durability (wear resistance) | Very Good | Very Good | Poor |
| Reusability (washability) | Very Good | Very Good | Poor |

As shown in the Table 3 as for the durability (wear resistance), a visible fine scratch is observed on the inner circumferential surface of the hole of the lid of Comparative Example B-1. In contrast, the inner circumferential surface of the lid of the containers of Examples B-1 and B-2 retains the clean surface having no scratch etc. with visual observation similarly to the initial surface.

It is found from this result that the products of Examples B-1 and B-2 have the hard DLC layer, the low frictional property, and excellent wear resistance even with repeated insertion and extraction of the liquid level sensor, and thereby no scratch is generated on the inner circumferential surface of the hole to retain the clean surface as in the unused state. Therefore, it is presumed that the liquid in the container is not contaminated with a foreign matter generated from such a scratch and a foreign matter such as a fragment derived from plastics around the gasket and sensors. Meanwhile, it is presumed that, in the product of Comparative Example B-1 without the coating of the DLC layer, the liquid in the container may be contaminated with the foreign matter.

As shown in the Table 3 as for the reusability (washability), when a colored foreign matter is found on a portion with a fine scratch in the resin coating of the fluororesin in the container of Comparative B-1, it is difficult to wash out the foreign matter the washing water due to water repellency. To remove the foreign matter, it is necessary to dissolve etc. the foreign matter with a solvent such as acetone. In contrast, the containers of Examples B-1 and B-2 have the inner surface coated with the DLC layer, and thereby the foreign matter can be easily washed with a mixed solvent of a solvent such as acetone and water.

As noted above, in the products of Examples B-1 and B-2 provided with the coating layer composed of the DLC layer, the DLC layer is more hydrophilic (has smaller contact angle with water) than the coating layer with the fluororesin, and thereby has excellent easy washability.

Meanwhile, in the product of Comparative Example B-1, the fluororesin layer being the coating layer has higher water repellency than the DLC layer, thereby the chemical reagent tends to remain in the concave portion, and it is presumed that the product has difficulty in washing compared with the products of Examples B-1 and B-2.

Specifically, when the organotin compound represented by the chemical formula (1) is treated and the container for a chemical reagent is washed with nitric acid, hydrofluoric acid, or a mixed aqueous solution thereof, all metals such as iron, including stainless steel, copper, aluminum, or an alloy of these metals corrode due to hydrofluoric acid, and thereby the metal constituting the container may be eluted. In this case, specifically a case of the organotin compound hardly washed with single nitric acid aqueous solution increases opportunity of washing by using hydrofluoric acid, and thereby the metal container in which the metal surface and the content are contacted may fail to be used as it is.

Next, a specimen for an elution test is prepared.

### Example B-3 (Specimen 1)

Prepared is a SUS304 plate with 2 mm in thickness and 3 cm×5 cm in size. In this plate, a hole in which a tying band to penetrate is provided on the end.

On both surfaces of the SUS304 plate, a coating layer composed of DLC is provided at approximately 10 μm. At this time, a first DLC layer having a hydrogen content of 25% is provided at a thickness of 7 μm so as to be contacted with the SUS304 plate. Thereon, a second ta-c DLC layer having a hydrogen content of not greater than 5% is provided at a thickness of 3 μm.

### Comparative Example B-2 (Specimen 2)

The SUS304 plate with 2 mm in thickness and 3 cm×5 cm in size prepared in the Example B-3 is used as it is without coating.

### Comparative Example B-3 (Specimen 3)

Both the surfaces of the SUS304 plate with 2 mm in thickness and 3 cm×5 cm in size prepared in the Example B-3 are coated with polytetrafluoroethylene (PTFE) at appropriately 15 μm.

### Method for Elution Test

Preparation of Ferric Chloride Solution: Into 45 mL of 1 N hydrochloric acid, 885 mL of desalted water is added, and 54 g of iron (III) chloride hexahydrate (FeCl3·6H2O) is dissolved thereinto. As above, 900 mL of 6% ferric chloride solution is prepared.

Setting of Specimen: Two beakers with 300 mL are prepared, and vertically stood so that a short side of the specimen is contacted with a bottom surface of the beaker. At this time, a tying band is passed through the hole of the specimen to fix the specimen.

Immersion: The aforementioned ferric chloride solution is poured into each of the beakers until a height of 3 cm. That is, the specimens 1 and 2 are each immersed in iron (III) chloride hexahydrate until a height of 3 cm (3 cm×3 cm×0.2 cm on both the surfaces).

Weighing: After left to stand in the ferric chloride solution at room temperature (25° C.) for 72 hours, the specimens are immersed in desalted water at approximately 50° C. for 20 minutes. Thereafter, each of the specimens is softly wiped with sponge, air-dried, and weighed.

As a result, changes in the mass are:
0.00 g/m²·hr in the specimen 1 (Example B-3);
−6.12 g/m²·hr in the specimen 2 (Comparative Example B-2); and
+0.01 g/m²·hr in the specimen 3 (Comparative Example B-3).

This result demonstrates that the stainless steel metal provided with the two DLC coating layers (Example B-3) inhibits elution of the metal, and thereby use of the metal container provided with the DLC layer can inhibit metal contamination of the organotin compound. It is presumed that dust etc. are adsorbed with static electricity on the specimen 3 (Comparative Example B-3).

In addition, inhibition of elution of the metal constituting stainless steel can also prevent contact between the metal surface and the organotin compound being the content, and thereby can prevent characteristic transmetalation of the organotin compound to prevent contamination with the metal impurity.

According to the present metal container, the initial purity of the organotin compound can be kept without contamination of the organotin compound contained in the container with a foreign matter even by storage and transfer in a long term. Therefore, the metal container for an organotin compound is useful for stably providing semiconductor products with excellent quality.

The specific embodiments of the present disclosure have been demonstrated in the above Examples, but the above Examples are merely examples and should not be limitedly interpreted. Various modifications obvious to a person skilled in the art are intended to be included within the scope of the present disclosure.

### REFERENCE SIGNS LIST

1 CONTAINER BODY
3 FLUORINE-CONTAINING DLC LAYER
8 FIRST DLC LAYER
9 SECOND DLC LAYER

1. A metal container for an organotin compound, wherein
the metal container comprises an inner surface having a diamond-like carbon layer coating,
the diamond-like carbon layer is (A) a fluorine-containing diamond-like carbon layer or (B) at least two diamond-like carbon layers different from each other, and
the diamond-like carbon layer has a thickness of 50 to 15,000 nm.

2. The metal container for an organotin compound according to claim 1, wherein the metal container comprises a metal selected from iron, nickel, copper, aluminum, and alloys thereof.

3. The metal container for an organotin compound according to claim 1, wherein the metal container comprises austenitic stainless steel.

4. The metal container for an organotin compound according to claim 3, wherein the austenitic stainless steel is vacuum double-melted SUS316L.

5. The metal container for an organotin compound according to claim 1, further comprising a bottom having an inner surface shape of an inverted truncated cone.

6. The metal container for an organotin compound according to claim 1, wherein the organotin compound is represented by the following chemical formula (1),
RpSnXm (1)
wherein R represents a hydrocarbon group optionally substituted with a halogen atom; p is an integer of 0 to 4; X represents a hydrolysable substituent; m is an integer of 0 to 4; and m+p is 2 or 4.

7. The metal container for an organotin compound according to claim 6, wherein R represents a hydrocarbon group optionally substituted with a halogen atom; p is an integer of 1 to 3; X represents a hydrolysable substituent; m is an integer of 1 to 3; and m+p is 2 or 4.

8. The metal container for an organotin compound according to claim 1, wherein the organotin compound has a purity of not less than 99 mol %.

9. The metal container for an organotin compound according to claim 1, further comprising a lid comprising a hole through which the inner surface can be observed with a borescope.

10. The metal container for an organotin compound according to claim 1, wherein the at least two diamond-like carbon layers have hydrogen atom contents different from each other.

11. The metal container for an organotin compound according to claim 1, wherein, in the two diamond-like carbon layers, a first diamond-like carbon layer contacted with a container body is a-C:H (hydrogenated amorphous carbon) having a hydrogen atom content of 20 to 40 at %.

12. The metal container for an organotin compound according to claim 1, wherein, in the two diamond-like carbon layers, a second diamond-like carbon layer contacted with the organotin compound is ta-C (tetrahedral amorphous carbon) having a hydrogen atom content of not greater than 5 at %.

13. A method for reusing the metal container for an organotin compound according to claim 1, the method comprising steps of:
containing an organotin compound in the metal container;
using the contained organotin compound; and then
containing again a new organotin compound,
wherein the method further comprises a step of washing the metal container with at least one liquid selected from the group consisting of nitric acid, hydrofluoric acid, and water before the step of containing again the new organotin compound.

14. A method for storing an organotin compound, the method comprising steps of:
containing an organotin compound in a metal container, wherein the metal container comprises an inner surface having a diamond-like carbon layer coating and the diamond-like carbon layer is (A) a fluorine-containing diamond-like carbon layer or (B) at least two diamond-like carbon layers different from each other, and
enclosing a noble gas or a mixture of noble gases in the metal container.
